(19) United States
(12) Patent Application Publication
(10) Pub. No.: US 2025/0180290 A1
(43) Pub. Date: Jun. 5, 2025

(54) FREEZE-DRYING DEVICE

(71) Applicant: Lyophitech, Venissieux (FR)

(72) Inventors: Jean Delaveau, Lyon (FR); Xavier Galland, Villeurbanne (FR)

(21) Appl. No.: 18/840,226

(22) PCT Filed: Feb. 27, 2023
(86) PCT No.: PCT/EP2023/054873

§ 371 Date: Aug. 21, 2024

(30) Foreign Application Priority Data
Mar. 1, 2022 (FR) 2201800

(51) Int. Cl. F26B 11/02; F26B 5/06

(52) U.S. Cl. CPC F26B 11/022; F26B 5/06; F26B 11/028

(57) ABSTRACT

A freeze-drying device includes an evaporation chamber that is mounted so as to be rotated on a shaft, a condensation chamber in communication with the evaporation chamber, and a product inlet and a product outlet which are connected to the evaporation chamber by first flexible connectors. The product inlet and the product outlet are fixedly mounted relative to the evaporation chamber, and a motor which drives the shaft back and forth on itself. The condensation chamber is fixedly mounted relative to the evaporation chamber, and the evaporation chamber and the condensation chamber are connected by second flexible connectors.

### TECHNICAL FIELD

The invention relates to the field of devices ensuring a treatment of products by freeze-drying. The invention relates more specifically to devices performing a loose freeze-drying.

The invention has a particularly advantageous application in the fields of pharmaceutical preparation and food preparation and, more generally, for all high added value industries which require a freeze-drying preservation method. For example, the invention can be implemented in the field of biotechnology for producing inoculum in view of biomass fermentation, in the food field for freeze-drying fruits, vegetables, beverages and food preparations, in the health field for freeze-drying proteins, peptides, enzymes, bacteria, viruses, living cells, antibody-based sensitive formulations or sensitive molecules, plasma fraction or sensitive polymer formulations.

### BACKGROUND

Freeze-drying is a low-temperature dehydration operation which consists of removing by sublimation, the majority of water contained in a product. Freeze-drying makes it possible to obtain high quality end products without degrading the structure and by preserving a large part of the activity of the microorganisms or cells. Freeze-dried products have a long-term preservation capacity due to the lowering of activity of the water of the product.

Indeed, by lowering the activity of the water in the product, no living organism can develop and all of the chemical reactions which are made in the water cannot occur. The very low activity of the water also makes it possible to block any microbiological development activity. Thus, the shape and the appearance of freeze-dried products are well-preserved and their aromatic qualities are greater than those of products dried by spraying, fluidised bed or several-effect evaporator simple drying methods.

Furthermore, the transition of products from the frozen state to the dehydrated state, in the absence of a high proportion of liquid water, reduces the possibilities of developing weathering reactions. Another major technological advantage of freeze-drying is based on the capacity of freeze-dried products to be rapidly rehydrated thanks to the microscopic pores formed by ice over their surface at the time of freezing.

Using freeze-drying is, however, limited by its cost and remains less than using other drying methods. The low productivity in freeze-drying is due to the vacuum, discontinuous operating mode which results in significant treatment durations of between around ten hours and several days. The investment and operating costs are also high. For example, the energy consumption of a freeze-drying device is typically around 1500 to 2500 kWh per tonne of water to be removed.

Consequently, freeze-drying only applies for products having a high added value. In the food industries, coffee, herbs and aromatics, cooked dishes, or also ingredients which are sensitive to dehydration by heat (vegetables, fruits, fish products, etc.) can be mentioned. For dehydrated instant soups, food preparations and cereals for breakfasts, methods based on spraying or fluidised bed are commonly used, as they are clearly cheaper. The sectors of the pharmaceutical industries (vaccines, serum, medicines) and bio-industries (yeasts) are a lot more highly concerned by freeze-drying methods which are the only methods making it possible to obtain a preservation of an active ingredient (biological and/or medicinal drug activity) in a product stored at ambient temperature.

Freeze-drying requires the use of a device comprising an evaporation chamber, integrating heating means, configured to sublimate the water contained in frozen products, and a condensation chamber connected to the evaporation chamber. The condensation chamber integrates an ice trap making it possible to collect water vapour coming from the evaporation chamber. To do this, cooling means are disposed in the condensation chamber to cool the ice trap. The chambers are also put under vacuum by a vacuum pump so as to pass the triple point of water and enable the passage of water from the solid phase to the gaseous phase.

The freeze-drying method has a first step consisting of freezing the products in the evaporation chamber or before introducing products in this chamber. A rapid freezing is sought so as to form small ice crystals. Indeed, a freezing which is too slow has the effect of favouring the formation of voluminous crystals which can damage the structure of the product by tearing the walls of its cells, for example, for yeasts, viruses and animal or plant cells.

A second step consists of creating a vacuum in the evaporation chamber, the low pressure, generally less than 1 hPa, enabling water in the form of ice to be transformed into vapour without defrosting the products. To do this, the products receive a heat input to supply the energy necessary to the latent heat from the sublimation of the ice into vapour. Vapour penetrates into the condensation chamber conditioned to transform the water vapour into ice by using the ice trap kept at a low temperature, for example, −60° C.

This freeze-drying method thus makes it possible to extract up to 95% of the water contained in the products. Freeze-drying can make it possible to return the humidity of the product to an extremely low rate, of between 1% and 10% of the density of the product, and to prevent bacteria and mould proliferating and enzymes from triggering chemical reactions which can damage the product. It ensues that freeze-dried products are preserved for a very long time. In a hermetic packaging, away from humidity, light and oxygen, freeze-dried products can be preserved at ambient temperature for numerous years.

Loose freeze-drying is mainly used in the industrial sector, and in particular the food industry, as it makes it possible to treat large quantities of products over limited durations. Loose freeze-drying indeed makes it possible to obtain an average freeze-drying time of between five and fifty hours. Reducing the freeze-drying time makes it possible to reduce energy consumption, the production time and therefore the production cost. Furthermore, limiting the freeze-drying time reduces the exposure of the product to heat. It is thus possible to improve the quality of the freeze-dried product.

Loose freeze-drying however involves introducing a mixture of products in the freeze-dryer. Yet, there is a risk of agglomerating products, which could damage the quality of the freeze-dried products.

To resolve this problem, it is possible to move the freeze-dryer during the freeze-drying process. Rotary movements thus make it possible to avoid the agglomeration of products in the evaporation chamber during freeze-drying, while limiting the time of the freeze-drying process.

To do this, document WO 82/02246 describes a freeze-drying device formed of a cylinder having two concentric parts: respectively one central compartment acting as the evaporation chamber and one peripheral compartment acting as the condensation chamber. The two concentric chambers are installed on a rotary shaft making it possible to perform a rotary movement during freeze-drying to avoid the agglomeration of products.

However, this document involves opening the chambers to introduce and extract the products before and after freeze-drying. This opening is complex to implement, when it must also guarantee that the vacuum is applied to the chambers during freeze-drying.

To respond to this problem, document WO 2017/178740 proposes to use an evaporation chamber that is mounted on a rotary shaft controlled to move back and forth with a low angle of rotation, of between −90 and 90°. To avoid having to open the evaporation chamber before and after freeze-drying, this is connected to a product inlet and a product outlet which are fixed relative to the evaporation chamber. The product inlet and the product outlet are connected by flexible connectors to the evaporation chamber, such that the small back-and-forth movements lead to a deformation of the flexible connectors around the evaporation chamber without breaking the connection between the evaporation chamber and the product inlet and the product outlet.

However, in all current freeze-drying devices, the condensation chamber is disposed closest to the evaporation chamber, such that the vapour extracted from the products to be freeze-dried is very rapidly captured and stored in the condensation chamber. The immediate proximity of the two chambers can avoid the vapour condensing along the walls of the evaporation chamber and risks falling back into the products.

For freeze-drying devices using a rotary movement, such as described in documents WO 82/02246 and WO 2017/178740, the evaporation chamber and the condensation chamber are both moved on one same rotary shaft. In certain embodiments of document WO 2017/178740, it is even possible to use two condensation chambers. Thus, a powerful motor must be selected to be able to move all the chambers simultaneously. Yet, these motors consume a lot of energy and are large in size.

The technical problem that is proposed to resolve the invention is to implement a freeze-drying device using a rotary movement which consumes less energy and is more compact.

### SUMMARY OF THE INVENTION

The present invention aims to resolve this problem, by disconnecting the condensation chamber from the rotary shaft and by fixedly mounting it relative to the evaporation chamber. Only the evaporation chamber is thus moved by the motor, which makes it possible to select a less powerful, therefore less energy-consuming and more compact motor. Furthermore, the fixed condensation chamber is connected to the evaporation chamber in movement by flexible connectors, called “second flexible connectors”, which are capable of moving and of deforming to absorb the movements of the evaporation chamber relative to the condensation chamber.

Against all expectations, even if using second flexible connectors increases the distance between the evaporation chamber and the condensation chamber, it has been observed that the vapour generated by the evaporation chamber does not condense on the walls of the evaporation chamber or of the flexible connectors and does not fall back into the products being freeze-dried if the flexible connectors are correctly sized, i.e. if the type and the number of flexible connectors makes it possible to extract all the vapour produced according to the pressure and temperature parameters of the chambers. The quality of the freeze-dried products therefore remains unchanged. Thus, contrary to the constant teaching of the prior art, it is not necessary to place the condensation chamber directly in the proximity of the evaporation chamber.

To this end, the invention relates to a freeze-drying device comprising/
an evaporation chamber comprising means for heating said evaporation chamber configured to perform a sublimation of the solvent contained in the frozen products intended to be disposed in said evaporation chamber, said evaporation chamber being mounted so as to be rotated on a shaft.
at least one condensation chamber in communication with said evaporation chamber, and comprising means for cooling said condensation chamber configured to transform the vapour coming from said evaporation chamber into ice;
a product inlet and a product outlet connected to said evaporation chamber by first flexible connectors, the product inlet and product outlet being fixedly mounted relative to the evaporation chamber, and
a motor which drives said shaft back and forth on itself according to:
a first movement which drives said shaft in a first direction of rotation with an angle of rotation of between 5° and 90°; and
a second movement which drives said shaft in a second direction of rotation, opposite the first angle of rotation, with an angle of rotation of between −5° and −90°.

The invention is characterised in that the at least one condensation chamber is fixedly mounted relative to said evaporation chamber, said evaporation chamber and said at least one condensation chamber being connected by second flexible connectors.

In certain embodiments, the device comprises at least two condensation chambers. A vapour collector provided with means for controlling the vapour flow rate can thus be disposed between the evaporation chamber and the condensation chambers. The vapour collector thus receives the vapour coming from the evaporation chamber and controls the vapour flow rate sent to each condensation chamber according to the trapping capacity of said condensation chamber.

According to the invention, the trapping capacity corresponds to the vapour flow rate being able to be condensed by the condensation chamber in a predetermined time interval. In practice, this trapping capacity can change over time. For example, the vapour can be condensed by an ice trap taking the form of a wound tube, in which a heat-transfer fluid flows, for example, liquid nitrogen.

When the vapour comes into contact with the ice trap, it solidifies on the wall of the trap. Thus, ice accumulates in layers on the walls of the trap. The thicker this ice layer is, the less effective the trap is. The trapping capacity of the condensation chamber thus decreases, and it can be useless to send the vapour to another trap via the vapour collector, expecting the trap to regenerate and achieve sufficient performance levels.

In practice, in order to limit energy losses linked to passing through the second flexible connectors connecting the condensation chamber to the evaporation chamber, it is possible to determine the optimal number of flexible connectors. This determination of the number of flexible connectors depends on several parameters, such as the pressure and the temperature of the evaporation and condensation chambers, the desired flow rate for treating products to be freeze-dried, and the diameter and the length of the flexible connectors available.

In practice, when all the other parameters are set, the number N of flexible connectors is proportional to the vaporisation flow rate of the evaporation chamber 5.

When it is sought to evaporate a solvent with an evaporation flow rate, and when the evaporation and condensation chambers have the following parameters:
the evaporation chamber has an operating temperature of between −30° C. and −20° C., a pressure of between 200 and 600 μbars, and
the condensation chamber has an operating temperature of between −100 and −50° C., a pressure of between 40 and 200 μbars.

Thus, the second flexible connectors are selected with:
a diameter of between 0.08 and 0.12 m,
a length of between 2 and 10 m, and
a number of flexible connectors proportional to the evaporation flow rate, with a proportionality coefficient of between 0.7 and 1.

There are different embodiments in which parameters can be fixed, according to the constraints linked to the operation of certain products to be freeze-dried, for example. Typically, the nature of the solvent can require particular pressure and temperature ranges to perform the freeze-drying.

According to a first embodiment, when it is sought to evaporate an aqueous solvent with an evaporation flow rate of between 10 and 11 kg/h, and when the evaporation and condensation chambers have the following parameters:
the evaporation chamber has an operating temperature of between −30° C. and −20° C., a pressure of between 400 and 580 μbars, and
the condensation chamber has an operating temperature set at −60° C., a pressure set at 100 μbars.

Thus, the second flexible connectors are selected with:
a diameter of between 0.1 and 0.105 m,
a length of between 3 and 4.5 m, and
a number of flexible connectors of between 7 and 13.

According to a second embodiment, when it is sought to evaporate an aqueous solvent with an evaporation flow rate of between 9 and 11 kg/h, and when the evaporation and condensation chambers have the following parameters:
the evaporation chamber has an operating temperature of −20° C., a pressure of 600 μbars, and
the condensation chamber has an operating temperature of between −100 and −50° C., a pressure of between 100 and 200 μbars.

Thus, the second flexible connectors are selected with:
a diameter set at 0.08 m,
a length set at 3 m, and
a number of flexible connectors of between 11 and 13.

According to a third embodiment, when it is sought to evaporate an aqueous solvent with an evaporation flow rate set at 9 kg/h, and when the evaporation and condensation chambers have the following parameters:
the evaporation chamber has an operating temperature of −30° C., a pressure of 600 μbars, and
the condensation chamber has an operating temperature set at −60° C., a pressure of between 100 and 200 μbars.

Thus, the second flexible connectors are selected with:
a diameter set at 0.08 m,
a length of between 3 and 7 m, and
a number of flexible connectors of between 10 and 15.

According to a fourth embodiment, when it is sought to evaporate an aqueous solvent with an evaporation flow rate set at 10 kg/h, and when the evaporation and condensation chambers have the following parameters:
the evaporation chamber has an operating temperature of −20° C., a pressure of between 200 and 250 μbars, and
the condensation chamber has an operating temperature set at −60° C., a pressure set at 100 μbars.

Thus, the second flexible connectors are selected with:
a diameter set at 0.12 m,
a length of between 2 and 3 m, and
a number of flexible connectors of between 11 and 18.

According to a fifth embodiment, when it is sought to evaporate an aqueous solvent with an evaporation flow rate set at 11 kg/h, and when the evaporation and condensation chambers have the following parameters:
the evaporation chamber has an operating temperature of between −30° C. and −10° C., a pressure of between 400 and 550 μbars, and
the condensation chamber has an operating temperature set at −70° C., a pressure set at 100 μbars.

Thus, the second flexible connectors are selected with:
a diameter set at 0.1 m,
a length set at 4 m, and
a number of flexible connectors of between 9 and 13.

According to a sixth embodiment, when it is sought to evaporate an organic solvent having an apparent molar mass of between 0.02 and 0.025 kg/mol, with an evaporation flow rate of 10 kg/h, and when the evaporation and condensation chambers have the following parameters:
the evaporation chamber has an operating temperature set at −15° C., a pressure set at 300 μbars, and
the condensation chamber has an operating temperature set at −70° C., a pressure set at 100 μbars.

Thus, the second flexible connectors are selected with:
a diameter set at 0.12 m,
a length of between 5 and 8 m, and
a number of flexible connectors of between 9 and 14.

According to a seventh embodiment, when it is sought to evaporate an organic solvent having an apparent molar mass set at 0.025 kg/mol, with an evaporation flow rate of 10 kg/h, and when the evaporation and condensation chambers have the following parameters:
the evaporation chamber has an operating temperature of between −30° C. and −20° C., a pressure set at 300 μbars, and
the condensation chamber has an operating temperature of between −90 and −70° C., a pressure of between 50 and 100 μbars.

Thus, the second flexible connectors are selected with:
a diameter set at 0.1 m,
a length of between 7 and 10 m, and
a number of flexible connectors of between 18 and 24.

### BRIEF DESCRIPTION OF THE FIGURES

The manner of carrying out the invention, as well as the advantages resulting from it, will become apparent from the description of the embodiment below, made with reference to the accompanying figures, in which:

FIG. 1 is a schematic, structural representation of a freeze-drying device according to a first embodiment of the invention;

FIG. 2 is a schematic, structural representation of a freeze-drying device according to a second embodiment of the invention;

FIG. 3 is a cross-sectional view of the position of a partition relative to the evaporation chamber in a first position of the freeze-drying device of FIG. 1;

FIG. 4 is a cross-sectional view of the position of a partition relative to the evaporation chamber in a second position of the freeze-drying device of FIG. 1; and

FIG. 5 is a cross-sectional view of the position of a partition relative to the evaporation chamber in a third position of the freeze-drying device of FIG. 1.

### DETAILED DESCRIPTION

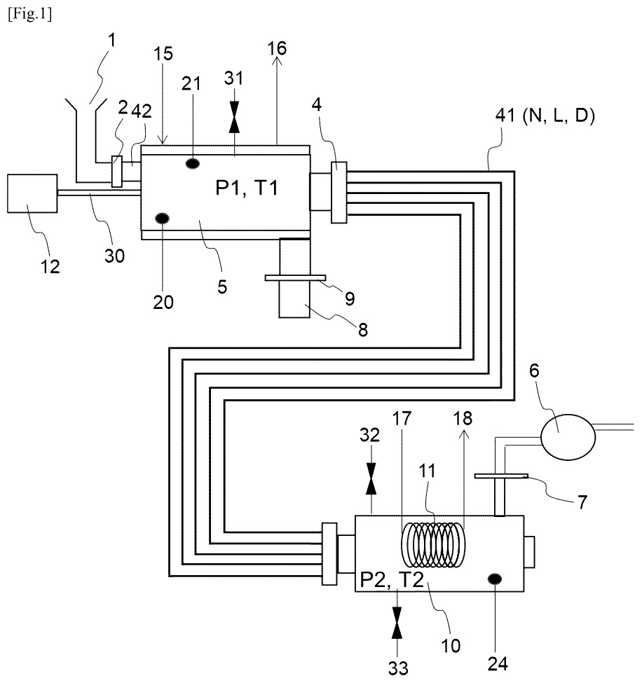

FIG. 1 illustrates a freeze-drying device comprising an evaporation chamber 5 and a condensation chamber 10. An inlet 1 in the form of a hopper is connected to the evaporation chamber 5 through a first flexible connector 42. The hopper is further equipped with a first lock 2 so as to introduce products to be freeze-dried when the lock 2 is open. An outlet 8 in the form of a hopper is also connected to the evaporation chamber 5 through a flexible connector. The hopper is further equipped with a second lock 9 so as to extract the freeze-dried products when the lock 9 is open. The locks 2 and 9 also make it possible to guarantee the sealing and the sterility of the chambers 5, 10. For example, locks 2, 9 of the trademark “Agilent Technologies” or “Gericke” can be used. In a variant, the invention can be implemented with one single inlet/outlet performing the two functions of introducing and extracting the products.

The evaporation chamber 5 has a double external wall in which a heat-transfer fluid flows to heat the evaporation chamber 5. Preferably, the internal surface of the evaporation chamber 5 is mirror polished so as to favour the sliding of the load and minimise the angle of repose.

The heat-transfer fluid is heated by an external device connected to the double wall by a fluid inlet 15 and a fluid outlet 16. A vapour inlet 31 is also connected to the evaporation chamber 5 in order to sterilise the evaporation chamber 5.

These heating means 15, 16 make it possible to perform a sublimation of the frozen products disposed in the evaporation chamber. In a variant, the heat-transfer fluid can be heated by a heat exchanger coupled with an external heat source. Preferably, the heating can be ensured by an electric heating coat powered via flexible electric cables. The heating coat is made of silicone and a heating resistance makes it possible to transform the electric energy into heat.

This heating system is advantageous, since the electric cables are more flexible and consequently more resistant with respect to the shearing stresses linked to the back-and-forth movements of the evaporation chamber compared with a pipe transporting a heat-transfer fluid.

The products can be introduced in a frozen form by the inlet 1. In a variant, the products can be frozen directly in the evaporation chamber 5. In this embodiment, the products are introduced at ambient temperature and the heat-transfer fluid circulating in the external double wall is refrigerated to a very low temperature, for example around −60° C., so as to lead to the freezing of the products before the evaporation step. A freezing can also be performed in the inlet 1. For example, the freezing can be obtained directly in pellets by means of a drop by drop, falling into a nitrogen current.

The condensation chamber 10 is connected to the evaporation chamber 5 through second flexible connectors 41. In a variant, several condensation chambers 10 can be connected to the evaporation chamber 5 through second flexible connectors 41. In certain embodiments, the second flexible connectors 41 are connected to the condensation chamber through a vapour collector not represented in the figures. The second flexible connectors 41 power the vapour collector via a vapour inlet. The vapour collector comprises several vapour outlets connected to different inlets distributed regularly along the condensation chamber 10. The latter is thus powered by several inlet flows, which makes it possible to best distribute the vapour in the chamber and avoid condensation.

The passage of the vapour through the second flexible connectors 41, between the evaporation chamber 5 and the condensation chamber 10 is controlled via an airlock 4. The airlock 4 can comprise a grid or a filter letting the vapour pass and retaining the particles of the product risking being driven by the water vapour. Preferably, the filter is made of Gore-Tex®, trademark.

The condensation chamber 10 comprises an ice trap 11 taking the form of a wound tube, in which a heat-transfer fluid flows, for example, liquid nitrogen. The heat-transfer fluid is produced by an external device and it is driven into the pipe through an inlet 17 up to an outlet 18. In a variant, the heat-transfer fluid can be cooled by a heat exchanger coupled with an external cold source.

The cooling means 17, 18 are implemented when the airlock 4 is open and that the vapour penetrates into the condensation chamber. The vapour thus freezes on the tube of the ice trap 11. The number of turns and the cross-section of the tube forming the ice trap 11 are determined according to the quantity of vapour to be recovered.

A vapour inlet 32 is also connected to the condensation chamber 10 in order to sterilise the condensation 10 and evaporation chambers prior to the starting up of the freeze-drying method, strictly speaking. To do this, in a step prior to the freeze-drying, the airlock 4 is open and vapour is introduced into the two chambers 5, 10.

During the method, strictly speaking, the vapour injected through the vapour injection nozzle 32 leads to the melting of the ice present on the ice trap 11. A purge 33 thus extracts the injected vapour to evaporate the ice contained in the condensation chamber 10 as well as the vapour generated for the sterilisation.

The condensation chamber 10 is also connected to a vacuum pump 6 through a pipe provided with a valve 7. This vacuum pump 6 is configured to put the condensation chamber 10 and the evaporation chamber 5 under vacuum when the airlock 4 is open. When the vacuum is created in these two chambers, the valve 7 is kept open and the vacuum is preserved by the condensation of vapour on the ice trap 11. For example, the vacuum values are between 10 μbar and 600 μbar.

The evaporation chamber 5 is mounted secured to a rotary shaft 30, while the condensation chamber 10 is fixedly mounted relative to the evaporation chamber 5. Preferably, the evaporation chamber 5 is cylindrical and the shaft 30 passes through the centre of the two flat faces of the cylinder, so as to uniformly distribute the mass of the evaporation chamber 5 around the shaft 30. The shaft 30 is rotated by a motor 12.

According to the invention, two rotary movements opposite the evaporation chamber are induced by the shaft 30 driven by the shaft 12 and are limited in amplitude so as to create a back-and-forth movement.

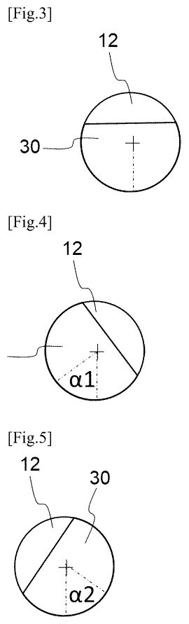

FIGS. 3 to 5 illustrate the positions of the shaft 30 during this back-and-forth movement. In a first position, illustrated in FIG. 3, the shaft 30 is not rotated by the motor 12. A first movement of the motor 12, illustrated in FIG. 4, drives the shaft 30 on itself and consequently of the evaporation chamber 5 in a first direction of rotation with an angular movement α1 less than 180°.

A second movement of the motor 12, illustrated in FIG. 5, drives the shaft 30 on itself and consequently the evaporation and condensation chambers in a second direction of rotation, opposite the first direction of rotation, with an angular movement α2 substantially equal to the angular movement of the first movement. The back-and-forth movement thus corresponds to a balancing of the shaft 30, i.e. a rotation of the shaft 30 on itself in one direction then in the other. The shaft 30 therefore does not completely rotate, thus limiting the risk of winding of the flexible connectors connecting the external devices of the evaporation chamber 5. On the contrary, the flexible connectors are configured to deform and absorb the movements of the evaporation chamber 5 during rotations, so as to maintain a sealed and sterile connection.

Rotary movements thus make it possible to avoid the agglomeration of products in the evaporation chamber 5 during freeze-drying, while limiting the time of the freeze-drying process. Advantageously, the evaporation chamber 5 also comprises baffles disposed inside the evaporation chamber 5.

The baffles extend radially towards the inside of the evaporation chamber 5 and make it possible to improve the mixing of the products during freeze-drying. For example, ploughshares of the trademark “Palamatic®” can be used.

The shaft 30 can be mounted horizontally relative to the cylindrical body of the evaporation chamber 5. In this embodiment, the device advantageously comprises means for pivoting the shaft in the vertical plane making it possible to guide the products disposed in the evaporation chamber 5 towards the outlet 8 when the freeze-drying time is reached.

In a variant, the shaft 30 can be mounted with a bias, i.e. inclined in the vertical plane so as to guide the products towards the outlet 8 during the entire freeze-drying process. In this embodiment, the outlet 8 is lower than the inlet 1 so as to use gravity to move the freeze-dried products towards the outlet 8.

Thus, to respond to the rotary constraints of the evaporation chamber 5, the flexible connectors 41, 42 have the function of connecting a fixed element to a movable element, such as the evaporation chamber 5.

In this case, the inlet 1 and outlet 8 hoppers are connected to the evaporation chamber 5 by sterile, flexible sleeves. Advantageously, the means for heating and cooling the two chambers 5, 10 as well as the vacuum pump 6 are also connected to the respective chambers by first flexible connectors 42. Preferably, the first flexible connectors 42 are made of stainless steel to respond to the sterility constraints. The first flexible connectors 42 advantageously have turns so as to limit the strain hardening of the stainless steel. In a variant, other materials can be used without changing the invention. The first flexible connectors 42 make it possible to guarantee the connection of these elements with the evaporation chamber 5, even when these are rotated on themselves by the motor 12. According to the embodiments, the fixed condensation chamber 10 can also be connected to the discharge hoppers by flexible connectors or, on the contrary, be connected to the discharge hoppers by any other type of connector, since it does not have the same rotary constraints. The bending capacity of the first flexible connectors 42 makes it possible to absorb the movements of the evaporation chamber 5 relative to the external elements. The length of the connectors is also chosen to guarantee the maintaining of the connection during the rotation of the evaporation chamber 5. For example, the flexible connectors of the trademark “Stäubli®” or also “GECITECH®” can be used.

Furthermore, the condensation chamber 10 is also connected to the evaporation chamber by second flexible connectors 41.

Preferably, the second flexible connectors 41 are made of stainless steel or reinforced polyvinyl chloride (PVC) to respond to the temperature and sterility constraints. The second flexible connectors 41 advantageously have turns so as to limit strain hardening. In a variant, other materials can be used without changing the invention. The bending capacity of the second flexible connectors 41 makes it possible to absorb the movements of the evaporation chamber 5 relative to the condensation chamber 10. The length L of the second flexible connectors 41 is also chosen to guarantee the maintaining of the connection during the rotation of the evaporation chamber 5.

Furthermore, with the freeze-drying process being particularly dependent on the temperature and pressure differences, the chambers 5, 10 are preferably instrumented by temperature 20, 24 and pressure 21 sensors.

Two sensors 20, 21 are disposed in the evaporation chamber 5 to control the temperature and the pressure in the evaporation chamber 5. A third sensor 24 is disposed in the condensation chamber 10 to control the temperature of the condensation chamber 10. It ensues that an operator can monitor the freeze-drying process by means of sensors 20, 21, 24 and estimate the quantity of water removed from the products over time. It is thus possible to determine the precise moment for which a sought water concentration is reached to stop the freeze-drying.

In practice, it is not currently possible to find on the market, one single second flexible connector 41 of a sufficient diameter to correctly discharge vapour. The existing second flexible connectors 41 have either limited maximum sizes, or a rigidity which is too high. A compromise between a bend radius which is sufficiently small to limit the size and a sufficiently large diameter can however be determined, in order to limit the number of flexible connectors. In practice, to determine the number N, the diameter D and the length L of the second flexible connectors 41, a person skilled in the art can apply fluid mechanics laws.

The number N, the diameter D and the length L of the second flexible connectors 41 is in particular conditioned by the pressure P1, P2 and temperature T1, T2 conditions in the chambers 5 and 10 and measured by the sensors 20, 21, 24.

In particular, by fixing the other parameters, the number N of second flexible connectors 41 can be defined with a proportionality coefficient with the evaporation flow rate of the vapour contained in the evaporation chamber 5. The proportionality coefficient between the number N of second flexible connectors 41 and the evaporation flow rate depends on the length L is, for example, between 0.7 and 1.

There are different embodiments in which some of these parameters can be fixed, according to the constraints linked to the operation of certain products to be freeze-dried, for example. Typically, the nature of the solvent can require particular pressure and temperature ranges to perform the freeze-drying.

According to a first embodiment, it is sought to evaporate an aqueous solvent with an evaporation flow rate of between 10 and 11 kg/h.

When the condensation chamber has an operating temperature T2 set at −60° C. and a pressure P2 set at 100 μbars, then the evaporation chamber has an operating temperature T1 varying between −30° C. and −20° C., a pressure P1 varying between 400 and 580 μbars.

The second flexible connectors 41 are thus selected with
a diameter D of between 0.1 and 0.105 m,
a length L of between 3 and 4.5 m, and
a number N of flexible connectors of between 7 and 13.

According to a second example of an embodiment, it is sought to evaporate an organic solvent having an apparent molar mass of between 0.02 and 0.025 kg/mol, with an evaporation flow rate of 10 kg/h.

When the evaporation chamber 5 has an operating temperature T1 set at −15° C. and a pressure P1 set at 300 μbars, and the condensation chamber 10 has an operating temperature T2 set at −70° C. and a pressure P2 set at 100 μbars, then the second flexible connectors 41 are selected with:
a diameter D set at 0.12 m,
a length L of between 5 and 8 m, and
a number N of flexible connectors of between 9 and 14.

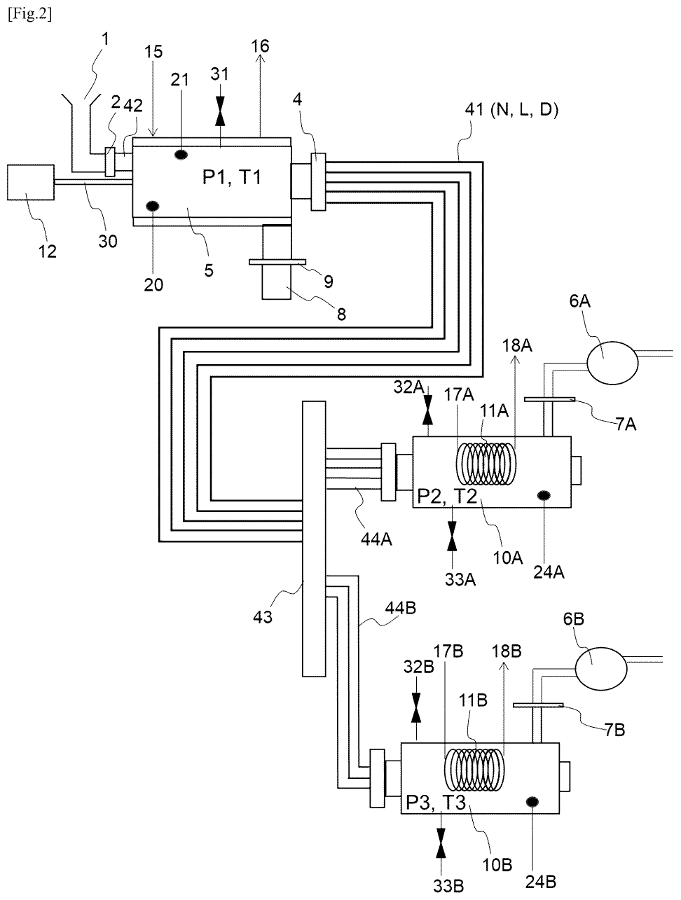

The freeze-drying device can also comprise several condensation chambers. Such as illustrated in FIG. 2, the freeze-drying device can, for example, comprise two condensation chambers 10A and 10B. In order to distribute the vapour coming from the evaporation chamber 5 between the two condensation chambers 10A and 10B, a vapour collector 43 can be added.

The vapour collector 43 is positioned at the outlet of the second flexible connectors 41 and is connected to the condensation chambers 10A and 10B by the connectors 44A, 44B. The number, the length and the diameter of the connectors 44A, 44B can be chosen according to the dimensions of the condensation chamber 10A, 10B considered.

The vapour collector 43 is fixedly mounted relative to the evaporation chamber 5. The vapour collector 43 and the condensation chambers 10A and 10B being fixed relative to the others, the connectors 44A, 44B can be rigid or flexible pipes without changing the invention.

Control means make it possible to modify the vapour flow rate sent to either of the condensation chambers 10A, 10B. The control means can be controlled manually or automatically, by positioning, for example, a sensor within each condensation chamber 10A, 10B. The sensor can thus measure the trapping capacity of the chamber and, according to the value of this measurement, the vapour flow rate sent to the chamber is adapted to enable the trap to regenerate.

For example, when the condensation chambers 10A, 10B comprise an ice trap 11A, 11B, the sensor can measure the thickness of the ice layer accumulated around the trap 11A, 11B. If this ice layer is thicker than a predetermined threshold, the vapour flow rate reaching the trap 11A, 11B can be decreased to leave time for the trap to regenerate by decreasing the thickness of the ice layer. During this time, the vapour flow rate reaching the other trap 11A, 11B can be increased to compensate the decreasing on the other trap and thus preserve a constant overall treatment flow rate.

To conclude, the invention makes it possible to develop a freeze-drying device which consumes less energy and is more compact.

1. A freeze drying device comprising:
an evaporation chamber comprising means for heating said evaporation chamber configured to perform a sublimation of the solvent contained in the frozen products intended to be disposed in said evaporation chamber, said evaporation chamber being mounted so as to be rotated on a shaft;
at least one condensation chamber in communication with said evaporation chamber, and comprising means for cooling said condensation chamber configured to transform the vapour coming from said evaporation chamber into ice;
a product inlet and a product outlet connected to said evaporation chamber by first flexible connectors, the product inlet and product outlet being fixedly mounted relative to the evaporation chamber, and
a motor which drives said shaft back and forth on itself according to:
a first movement driving said shaft in a first direction of rotation with an angle of rotation of between 5° and 90°; and
a second movement driving said shaft in a second direction of rotation, opposite the first angle of rotation, with an angle of rotation of between −5° and −90°;
wherein said at least one condensation chamber is fixedly mounted relative to said evaporation chamber, said evaporation chamber and said at least one condensation chamber being connected by second flexible connectors.

2. The freeze-drying device according to claim 1, wherein the device comprising at least two condensation chambers and one vapour collector provided with means for controlling the vapour flow rate, the vapour collector is disposed between the evaporation chamber and the condensation chambers, the vapour collector receives the vapour coming from the evaporation chamber and controls the vapour flow rate sent to each condensation chamber.

3. The freeze-drying device according to claim 1, wherein when it is sought to evaporate a solvent having an evaporation flow rate, and when the evaporation and condensation chambers have the following parameters:
the evaporation chamber has an operating temperature of between −30° C. and −20° C., a pressure of between 200 and 600 μbars,
the condensation chamber has an operating temperature of between −100 and −50° C., a pressure of between 40 and 200 μbars,
the second flexible connectors are selected with:
a diameter of between 0.08 and 0.12 m,
a length of between 2 and 10 m, and
a number of flexible connectors proportional to the evaporation flow rate, with a proportionality coefficient of between 0.7 and 1.

4. The freeze-drying device according to claim 1, wherein when it is sought to evaporate an aqueous solvent with an evaporation flow rate of between 10 and 11 kg/h, and when the evaporation and condensation chambers have the following parameters:
the evaporation chamber has an operating temperature of between −30° C. and −20° C., a pressure of between 400 and 580 μbars,
the condensation chamber has an operating temperature set at −60° C., a pressure set at 100 μbars,
the second flexible connectors are selected with:
a diameter of between 0.1 and 0.105 m,
a length of between 3 and 4.5 m, and
a number of flexible connectors of between 7 and 13.

5. The freeze-drying device according to claim 1, wherein when it is sought to evaporate an aqueous solvent with an evaporation flow rate of between 9 and 11 kg/h, and when the evaporation and condensation chambers have the following parameters:
the evaporation chamber has an operating temperature of −20° C., a pressure of 600 μbars,
the condensation chamber has an operating temperature of between −100 and −50° C., a pressure of between 100 and 200 μbars,
the second flexible connectors are selected with:
a diameter set at 0.08 m,
a length set at 3 m, and
a number of flexible connectors of between 11 and 13.

6. The freeze-drying device according to claim 1, wherein when it is sought to evaporate an aqueous solvent with an evaporation flow rate set at 9 kg/h, and when the evaporation and condensation chambers have the following parameters:
the evaporation chamber has an operating temperature of −30° C., a pressure of 600 μbars,
the condensation chamber has an operating temperature set at −60° C., a pressure of between 100 and 200 μbars,
the second flexible connectors are selected with:
a diameter set at 0.08 m,
a length of between 3 and 7 m, and
a number of flexible connectors of between 10 and 15.

7. The freeze-drying device according to claim 1, wherein when it is sought to evaporate an aqueous solvent with an evaporation flow rate set at 10 kg/h, and when the evaporation and condensation chambers have the following parameters:
the evaporation chamber has an operating temperature of −20° C., a pressure of between 200 and 250 μbars,
the condensation chamber has an operating temperature set at −60° C., a pressure set at 100 μbars,
the second flexible connectors are selected with:
a diameter set at 0.12 m,
a length of between 2 and 3 m, and
a number of flexible connectors of between 11 and 18.

8. The freeze-drying device according to claim 1, wherein when it is sought to evaporate an aqueous solvent with an evaporation flow rate set at 11 kg/h, and when the evaporation and condensation chambers have the following parameters:
the evaporation chamber has an operating temperature of between −30° C. and −10° C., a pressure of between 400 and 550 μbars,
the condensation chamber has an operating temperature set at −70° C., a pressure set at 100 μbars,
the second flexible connectors are selected with:
a diameter set at 0.1 m,
a length set at 4 m, and
a number of flexible connectors of between 9 and 13.

9. The freeze-drying device according to claim 1, wherein when it is sought to evaporate an organic solvent having an apparent molar mass of between 0.02 and 0.025 kg/mol, with an evaporation flow rate of 10 kg/h, and when the evaporation and condensation chambers have the following parameters:
the evaporation chamber has an operating temperature set at −15° C., a pressure set at 300 μbars,
the condensation chamber has an operating temperature set at −70° C., a pressure set at 100 μbars,
the second flexible connectors [(41)] are selected with:
a diameter set at 0.12 m,
a length of between 5 and 8 m, and
a number of flexible connectors of between 9 and 14.

10. The freeze-drying device according to claim 1, wherein when it is sought to evaporate an organic solvent having an apparent molar mass set at 0.025 kg/mol, with an evaporation flow rate of 10 kg/h, and when the evaporation and condensation chambers have the following parameters:
the evaporation chamber has an operating temperature of between −30° C. and −20° C., a pressure set at 300 μbars,
the condensation chamber has an operating temperature of between −90 and −70° C., a pressure of between 50 and 100 μbars,
the second flexible connectors are selected with:
a diameter set at 0.1 m,
a length of between 7 and 10 m, and
a number of flexible connectors of between 18 and 24.

11. The freeze-drying device according to claim 2, wherein when it is sought to evaporate an aqueous solvent with an evaporation flow rate of between 10 and 11 kg/h, and when the evaporation and condensation chambers have the following parameters:
the evaporation chamber has an operating temperature of between −30° C. and −20° C., a pressure of between 400 and 580 μbars,
the condensation chamber has an operating temperature set at −60° C., a pressure set at 100 μbars,
the second flexible connectors are selected with:
a diameter of between 0.1 and 0.105 m,
a length of between 3 and 4.5 m, and
a number of flexible connectors of between 7 and 13.

12. The freeze-drying device according to claim 2, wherein when it is sought to evaporate an aqueous solvent with an evaporation flow rate of between 9 and 11 kg/h, and when the evaporation and condensation chambers have the following parameters:
the evaporation chamber has an operating temperature of −20° C., a pressure of 600 μbars,
the condensation chamber has an operating temperature of between −100 and −50° C., a pressure of between 100 and 200 μbars,
the second flexible connectors are selected with:
a diameter set at 0.08 m,
a length set at 3 m, and
a number of flexible connectors of between 11 and 13.

13. The freeze-drying device according to claim 2, wherein when it is sought to evaporate an aqueous solvent with an evaporation flow rate set at 9 kg/h, and when the evaporation and condensation chambers have the following parameters:
the evaporation chamber has an operating temperature of −30° C., a pressure of 600 μbars,
the condensation chamber has an operating temperature set at −60° C., a pressure of between 100 and 200 μbars,
the second flexible connectors are selected with:
a diameter set at 0.08 m,
a length of between 3 and 7 m, and
a number of flexible connectors of between 10 and 15.

14. The freeze-drying device according to claim 2, wherein when it is sought to evaporate an aqueous solvent with an evaporation flow rate set at 10 kg/h, and when the evaporation and condensation chambers have the following parameters:
the evaporation chamber has an operating temperature of −20° C., a pressure of between 200 and 250 μbars,
the condensation chamber has an operating temperature set at −60° C., a pressure set at 100 μbars,
the second flexible connectors are selected with:
a diameter set at 0.12 m,
a length of between 2 and 3 m, and
a number of flexible connectors of between 11 and 18.

15. The freeze-drying device according to claim 2, wherein when it is sought to evaporate an aqueous solvent with an evaporation flow rate set at 11 kg/h, and when the evaporation and condensation chambers have the following parameters:
the evaporation chamber has an operating temperature of between −30° C. and −10° C., a pressure of between 400 and 550 μbars,
the condensation chamber has an operating temperature set at −70° C., a pressure set at 100 μbars,
the second flexible connectors are selected with:
a diameter set at 0.1 m,
a length set at 4 m, and
a number of flexible connectors of between 9 and 13.

16. The freeze-drying device according to claim 2, wherein when it is sought to evaporate an organic solvent having an apparent molar mass of between 0.02 and 0.025 kg/mol, with an evaporation flow rate of 10 kg/h, and when the evaporation and condensation chambers have the following parameters:
the evaporation chamber has an operating temperature set at −15° C., a pressure set at 300 μbars,
the condensation chamber has an operating temperature set at −70° C., a pressure set at 100 μbars,
the second flexible connectors are selected with:
a diameter set at 0.12 m,
a length of between 5 and 8 m, and
a number of flexible connectors of between 9 and 14.

17. The freeze-drying device according to claim 2, wherein when it is sought to evaporate an organic solvent having an apparent molar mass set at 0.025 kg/mol, with an evaporation flow rate of 10 kg/h, and when the evaporation and condensation chambers have the following parameters:
the evaporation chamber has an operating temperature of between −30° C. and −20° C., a pressure set at 300 μbars,
the condensation chamber has an operating temperature of between −90 and −70° C., a pressure of between 50 and 100 μbars,
the second flexible connectors are selected with:
a diameter set at 0.1 m,
a length of between 7 and 10 m, and
a number of flexible connectors of between 18 and 24.
